(19) United States
(12) Patent Application Publication
(10) Pub. No.: US 2013/0095889 A1
(43) Pub. Date: Apr. 18, 2013

(54) Filtering Mobile Communications Device Messages For Presentation Within An Automobile

(71) Applicants: Tuan A. Nguyen, Raleigh, NC (US); Jason A. Nikolai, Rochester, MN (US)

(72) Inventors: Tuan A. Nguyen, Raleigh, NC (US); Jason A. Nikolai, Rochester, MN (US)

(73) Assignee: INTERNATIONAL BUSINESS MACHINES CORPORATION, Armonk, NY (US)

(21) Appl. No.: 13/274,511

(22) Filed: Oct. 17, 2011

(51) Int. Cl. H04W 4/04

(52) U.S. Cl. 455/557

(57) ABSTRACT

Filtering mobile communications device messages for presentation within an automobile, the automobile coupled for data communications to a user's mobile communications device, and: responsive to the user's mobile communications device receiving a message, identifying, by a message display filter, message characteristics of the message; identifying, by the message display filter, environmental characteristics; and administering, by the message display filter, presentation of content of the message within the automobile in dependence upon the message characteristics, the environmental characteristics, and a predefined message filtering ruleset.

### BACKGROUND OF THE INVENTION

1. Field of the Invention

The field of the invention is data processing, or, more specifically, methods, apparatus, and products for filtering mobile communications device messages for presentation within an automobile.

2. Description Of Related Art

Currently in the automotive industry, vehicles are being equipped with the ability to display, on a display device in the vehicle's dashboard, Small Message System (‘SMS’) messages and other potentially private data received on a smart phone, PDA, or other mobile device. While this helps prevent drivers from having to look at a typically small display provided by a mobile device and reduce the number of accidents caused by driver distraction, this solution lacks security and privacy measures. More specifically, drivers may not desire to have others traveling in the same vehicle see private messages displayed on the dashboard display.

### SUMMARY OF THE INVENTION

Methods, apparatus, and products for filtering mobile communications device messages for presentation within an automobile are disclosed. The automobile is coupled for data communications to a user's mobile communications device. Filter such mobile communications device messages includes: receiving, by the user's mobile communications device, a message; identifying, by a message display filter, message characteristics of the message; identifying, by the message display filter, environmental characteristics; and administering, by the message display filter, presentation of content of the message within the automobile in dependence upon the message characteristics, the environmental characteristics, and a predefined message filtering ruleset.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram of a system for filtering mobile communications device messages for presentation within an automobile according to embodiments of the present invention.

FIG. 2 sets forth a flow chart illustrating an exemplary method for filtering mobile communications device messages for presentation within an automobile according to embodiments of the present invention.

FIG. 3 sets forth a flow chart illustrating an exemplary method for filtering mobile communications device messages for presentation within an automobile according to embodiments of the present invention.

FIG. 4 sets forth a flow chart illustrating an exemplary method for filtering mobile communications device messages for presentation within an automobile according to embodiments of the present invention.

### DETAILED DESCRIPTION OF EXEMPLARY EMBODIMENTS

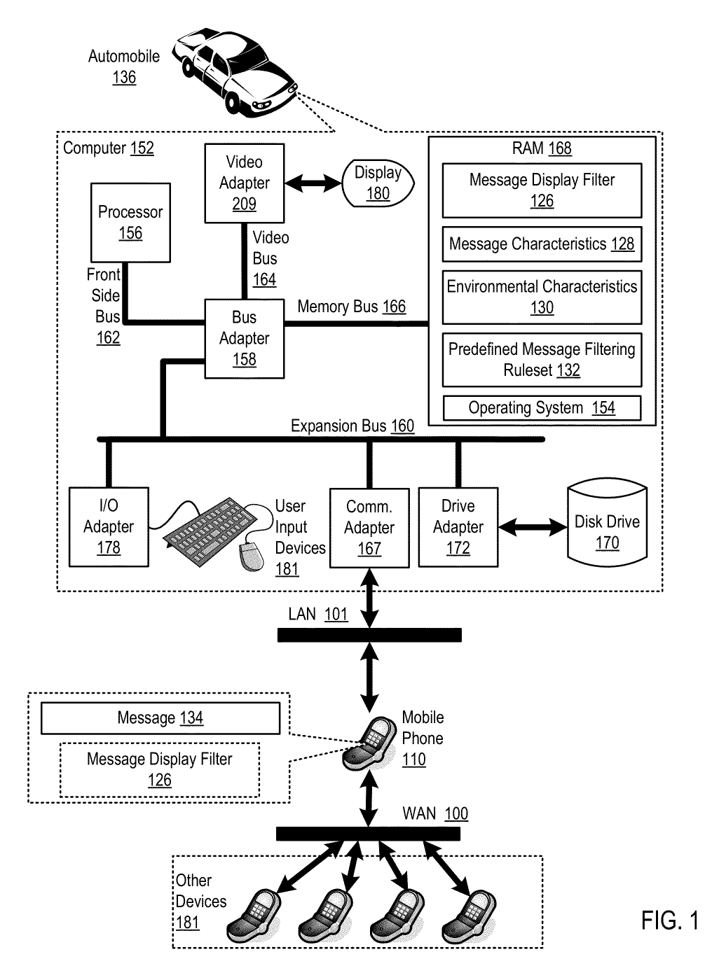

Exemplary methods, apparatus, and products for filtering mobile communications device messages for presentation within an automobile in accordance with the present invention are described with reference to the accompanying drawings, beginning with FIG. 1. FIG. 1 sets forth a network diagram of a system for filtering mobile communications device messages for presentation within an automobile according to embodiments of the present invention. The system of FIG. 1 includes an automobile (136) which in turn includes a computer (152).

The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152). The computer (152), through the communication adapter (167) couples a user's mobile communication device—a mobile phone (110) in this example—to the automobile (136) for data communications. Readers of skill in the art will recognize that that mobile communication devices may take various forms—tablets, PDAs, multimedia players, and so on.

The mobile phone (110) in the example of FIG. 1 may also be implemented with many of the same computing components found in the example computer (152). The mobile phone (110), for example, may include a processor and RAM and stored within that RAM may be an application configured for mobile communications. The mobile communications application may be configured to send and receive mobile communications messages to other devices (181), send and receive telephone calls, access wide area networks (100), and so on. In the example of FIG. 1, the mobile phone (110) receives a mobile communications device message (134). Examples of such messages may include email messages, Small Message System (‘SMS’) messages, Multimedia Messaging System (‘MMS’) messages, and so on as will occur to readers of skill in the art.

Stored in RAM (168) of the automobile's computer (152) is a message display filter (126), a module of computer program instructions configured for filtering mobile communications device messages for presentation within the automobile (136) in accordance with embodiments of the present invention. The message display filter (126) operates to filter mobile communications device messages by: identifying message characteristics (128) of the message; identifying environmental characteristics (130); and administering presentation of content of the message (134) within the automobile (136) in dependence upon the message characteristics (128), the environmental characteristics (130), and a predefined message filtering ruleset (132).

Message characteristics (128) of a message may take various forms including any combination of: a source identifier—sender's name or telephone number; a time the message was sent; a geographic location from which the message was sent; a device identifier from which the message was sent; and the content of the message itself.

Environmental characteristics (130) describe the environment within which a message was received. For example, environmental characteristics may include and combination of: presence of other individuals within the automobile at the time the message was received; weather conditions near the geographical location of the automobile at the time the message was received; a location of the automobile at the time the message was received; and a time of day that the message was received.

The predefined message filtering ruleset (132) is a data structure that includes rules governing the invocation of filtering actions when criteria are met. For example, the predefined message filtering ruleset (132) may include a rule that invokes a filter action of blocking all message content from being presented within the automobile when any individual other than the user is in the automobile and the message is received from a particular individual.

Consider, for example, the following rules, criteria, and filtering action which may be specified in the ruleset:
present message content only when no other individual is in the automobile;
present message content if less than two other individuals are present in automobile;
present only the sender's identification (name, telephone number, or email address) when another individual is present in the automobile;
present message content from a particular source, such texts from co-workers only during particular hours;
present message content only if message originates in a particular geographic location, such any location other than the user's home city when on the user is on vacation;
present message content only if the source identifier is included in a particular group and any other individual in the automobile is also included in the group;
present message content only under certain weather conditions and then only from a source identifier that is included in a predefined group;
present modified message content, replacing vulgar, graphic, security sensitive, or private content with symbols;
present message content of message one particular display among several available displays within the automobile if that message originates from a particular source identifier and other individuals are within the automobile; and
delaying presentation of message content until after the automobile exits a particular geographic location with dangerous driving conditions.

Although the message display filter (126) is described here as being stored in the RAM (168) of the automobile's (136) computer (152), readers of skill in the art will also recognize that the message display filter (126) may be implemented on the mobile phone (110). In this way, the mobile phone (110) may be coupled to various different automobiles configured to display message content within the automobile, and filter messages in each automobile.

Also stored in RAM (168) of the automobile's computer (152) is an operating system (154). Operating systems useful filtering mobile communications device messages for presentation within an automobile according to embodiments of the present invention include UNIX™ Linux™ Microsoft XP™ AIX™ IBM's i5/OS™ and others as will occur to those of skill in the art. The operating system (154), message display filter (126), message characteristics (128), environmental characteristics (130), and the predefined message filtering ruleset (132) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for filtering mobile communications device messages for presentation within an automobile according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with the mobile phone (110) and for data communications with a data communications network (101). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for filtering mobile communications device messages for presentation within an automobile according to embodiments of the present invention include modems for wired dial-up communications, Ethernet (IEEE 802.3) adapters for wired data communications network communications, and 802.11 adapters for wireless data communications network communications.

The arrangement of computers, mobile phones, and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

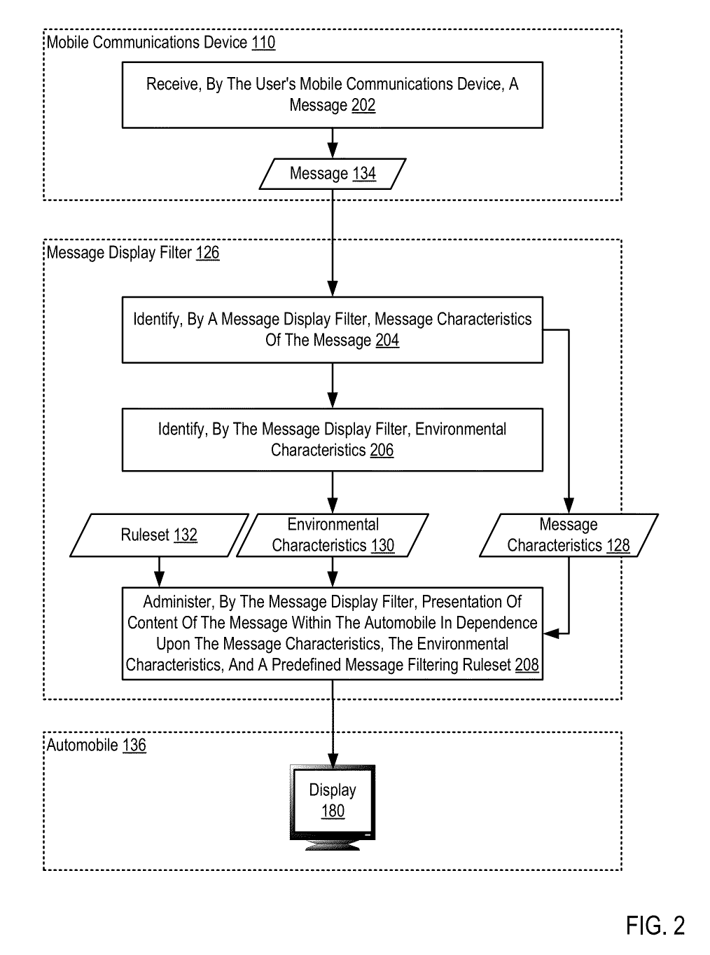

For further explanation, FIG. 2 sets forth a flow chart illustrating an exemplary method for filtering mobile communications device messages for presentation within an automobile according to embodiments of the present invention. The automobile (136) is coupled for data communications to a user's mobile communications device (110) and the method of FIG. 2 includes: receiving (202), by the user's mobile communications device, a message (134). The message (134) in the example of FIG. 2 may take various forms, such as, an SMS message that includes text, MMS message that includes audio, image, or video data, or an email message.

The method of FIG. 2 also includes identifying (204), by a message display filter, message characteristics of the message. The message display filter (126) may identify the message characteristics in various ways including, for example, by inspecting header data of the message, crawling text of the message, performing speech-to-text analysis of any audio or video content, and so on. Examples of message characteristics that may be identified (204) include any combination of a source identifier, a time the message was sent, a geographic location from which the message was sent, a device identifier from which the message was sent, and the content of the message—predefined words or phrases, for example.

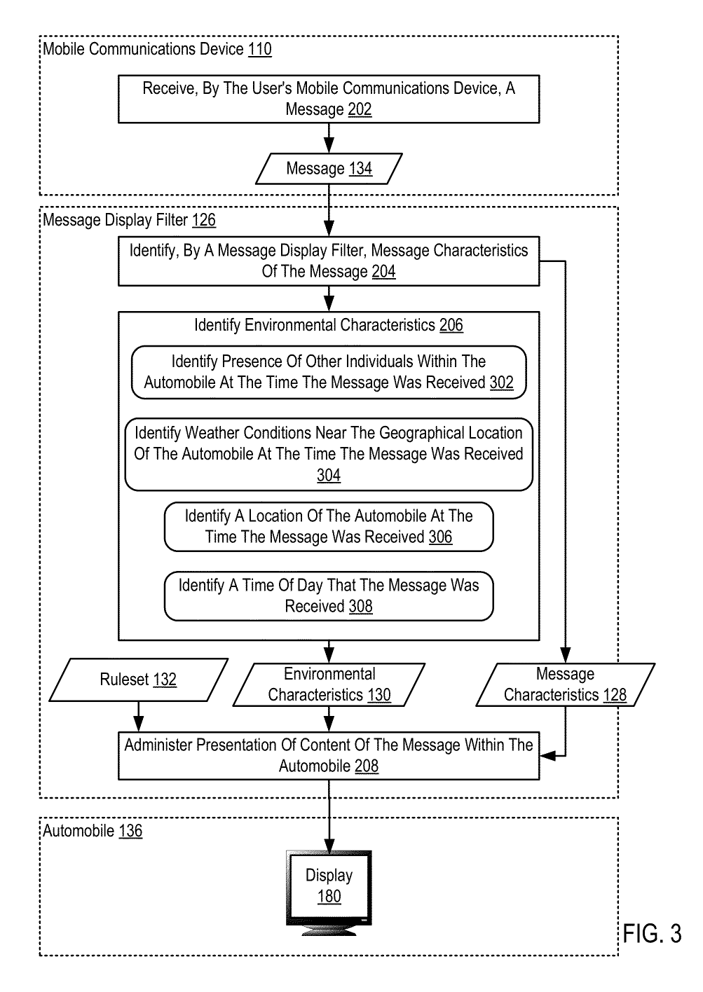

The method of FIG. 2 also includes identifying (204), by the message display filter (126), environmental characteristics (206). Environmental characteristics may be identified in various ways, described below in detail with respect to FIG. 3, including for example through Radio Frequency Identification (RFID), video or audio processing, gathering sensor data, retrieving weather information from a weather repository and in other ways depending upon the type of environmental characteristic being identified.

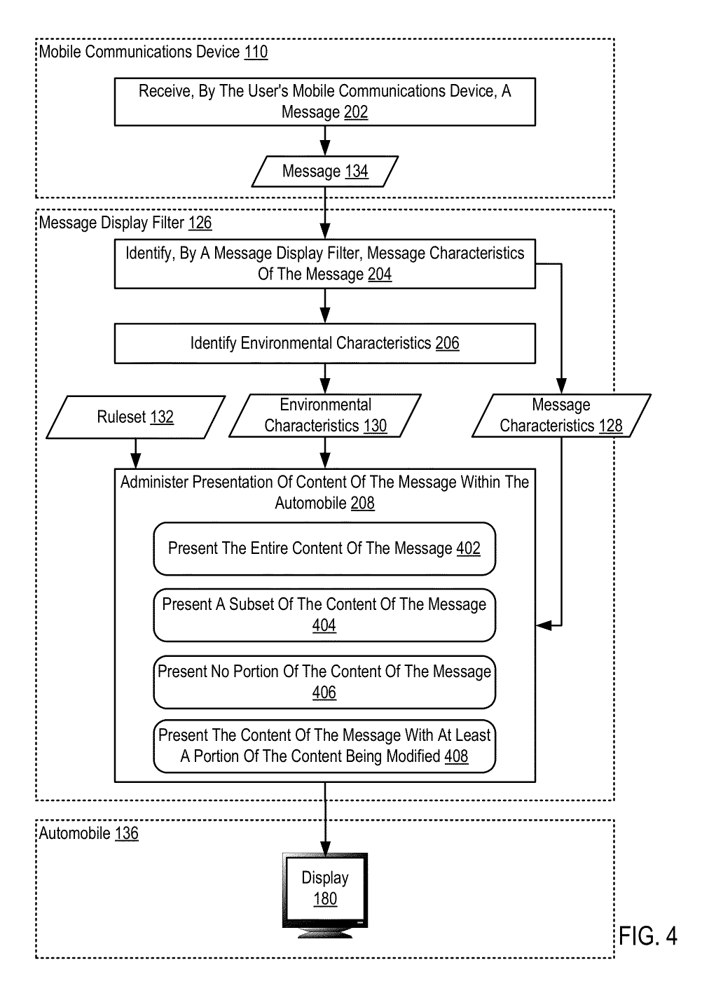

The method of FIG. 2 also includes administering (208), by the message display filter (126), presentation of content of the message within the automobile on the display (180) in dependence upon the message characteristics (128), the environmental characteristics (130), and a predefined message filtering ruleset (132). There are various ways in which the message display filter administers presentation of the content within the automobile which are discussed below with respect to FIG. 4.

Depending on the implementation of the message display filter (126)—whether implemented as part of the mobile communications device (110) or the automobile (136)—administering presentation of content of the message within the automobile may vary. For example, when the message display filter (126) is implemented as part of the mobile communications device (110), the message display filter may administer presentation of message content by sending to the automobile only that portion of message content to display. The automobile, in such an embodiment, operates as if a normal, unfiltered message has arrived and displays the message. By contrast, if the message display filter (126) is embodied as part of the automobile (136), the mobile communications device forwards the message along to the automobile without filtering the content at all. From the perspective of the mobile communications device in such an embodiment the mobile communications device operates the same for every message—whether the message ultimately is filtered or not.

Administering presentation of content may also include logging the filtering actions carried out by the message display filter. Such a log may be accessible by the user of the mobile communications device. In this way, the user may access the unfiltered version of the message at a later time and in a environment of the user's choosing.

For further explanation, FIG. 3 sets forth a flow chart illustrating an exemplary method for filtering mobile communications device messages for presentation within an automobile according to embodiments of the present invention. The method of FIG. 3 is similar to the method of FIG. 2, including as it does, receiving (202) a message by the mobile communications device, identifying (204) message characteristics (128), identifying (206) environmental characteristics (130), and administering (208) presentation of content of the message within the automobile (136).

The method of FIG. 3 differs from the method of FIG. 2, however, in that in the method of FIG. 3, identifying (206) environmental characteristics (130) is carried out by any combination of identifying (302) presence of other individuals within the automobile at the time the message was received; identifying (304) weather conditions near the geographical location of the automobile at the time the message was received; identifying (306) a location of the automobile at the time the message was received; and identifying (308) a time of day that the message was received.

Identifying (302) presence of other individuals within the automobile at the time the message was received may be carried out discovering within the automobile one or more additional mobile communications devices, each additional mobile communications device indicating presence of an additional other individual within the automobile. Such discovery may be carried out through standard protocols in Bluetooth, 802.11 wireless networks, out-of-band network communications, pinging all nearby RFID devices, and so on as will occur to readers of skill in the art. Identifying (302) presence of other individuals may also be carried out by monitoring audio and video feeds of the automobiles interior.

Identifying (304) weather conditions near the geographical location of the automobile at the time the message was received may be carried out retrieving a Global Positioning Satellite (‘GPS’) location of the mobile communications device or automobile and retrieving the weather information from a weather repository utilizing the GPS location. Identifying (306) a location of the automobile at the time the message was received may be carried out, again, by retrieving the retrieving a GPS location of the mobile communications device or automobile. Identifying (308) a time of day that the message was received may be carried out by pinging the system clock of the mobile communications device upon receipt o the message or by pinging the automobile's system clock.

For further explanation, FIG. 4 sets forth a flow chart illustrating an exemplary method for filtering mobile communications device messages for presentation within an automobile according to embodiments of the present invention. The method of FIG. 4 is similar to the method of FIG. 2, including as it does, receiving (202) a message by the mobile communications device, identifying (204) message characteristics (128), identifying (206) environmental characteristics (130), and administering (208) presentation of content of the message within the automobile (136).

The method of FIG. 4 differs from the method of FIG. 2, however, in that in the method of FIG. 4, administering (208) presentation of content of the message on the automobile's display further is carried out by one of: presenting (402) the entire content of the message; presenting (404) a subset of the content of the message; presenting (406) no portion of the content of the message; and presenting (408) the content of the message with at least a portion of the content being modified.

Presenting (404) a subset of the content of the message may be carried out in various ways including, for example, presenting only the sender's name, only the location from which the message was sent, only the first few words of the text of the message, and so on as will occur to readers of skill in this art. In this way, a user may preview some portion of the message and determine whether to reveal the remainder of the message.

Presenting (408) the content of the message with at least a portion of the content being modified may be carried out in various ways including, for example, by replacing predefined words—graphic language, for example—with symbols or other characters or inserting an audio or video overlay over particular language or video. In this way, graphic language, sensitive language, language with needed security or privacy can remain blocked from other individuals within the automobile while some of the message content is displayed in its original form.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of filtering mobile communications device messages for presentation within an automobile, the automobile coupled for data communications to a user's mobile communications device, the method comprising:
responsive to the user's mobile communications device receiving a message, identifying, by a message display filter, message characteristics of the message;
identifying, by the message display filter, environmental characteristics of an operating environment that is external to the user's mobile communications device; and
administering, by the message display filter, presentation of content of the message within the automobile in dependence upon the message characteristics, the environmental characteristics, and a predefined message filtering ruleset.

2. The method of claim 1 wherein the mobile communications device message comprises one of:
a Small Messaging System (‘SMS’) message; or
a Multimedia Messaging System (‘MMS’) message.

3. The method of claim 1 wherein identifying environmental characteristics further comprises any of:
identifying presence of other individuals within the automobile at the time the message was received;
identifying weather conditions near the geographical location of the automobile at the time the message was received;
identifying a location of the automobile at the time the message was received; and
identifying a time of day that the message was received.

4. The method of claim 2 wherein identifying presence of other individuals within the automobile at the time the message was received further comprises discovering within the automobile one or more additional mobile communications devices, each additional mobile communications device indicating presence of an additional other individual within the automobile.

5. The method of claim 1 wherein the message characteristics of the message further comprise any of:
a source identifier;
a time the message was sent;
a geographic location from which the message was sent;
a device identifier from which the message was sent; and
content of the message.

6. The method of claim 1 wherein administering presentation of content of the message on the automobile's display further comprises one of:
presenting the entire content of the message;
presenting a subset of the content of the message;
presenting no portion of the content of the message; and
presenting the content of the message with at least a portion of the content being modified.

7. The method of claim 1 wherein the message display filter comprises a module of automated computing machinery implemented within the user's mobile communications device.

8. The method of claim 1 wherein the message display filter comprises a module of automated computing machinery implemented within the automobile.

9. An apparatus for filtering mobile communications device messages for presentation within an automobile, the automobile coupled for data communications to a user's mobile communications device, the apparatus comprising a computer processor, a computer memory operatively coupled to the computer processor, the computer memory having disposed within it computer program instructions capable of:
responsive to the user's mobile communications device receiving a message, identifying, by a message display filter, message characteristics of the message;
identifying, by the message display filter, environmental characteristics of an operating environment that is external to the user's mobile communications device; and
administering, by the message display filter, presentation of content of the message within the automobile in dependence upon the message characteristics, the environmental characteristics, and a predefined message filtering ruleset.

10. The apparatus of claim 9 wherein the mobile communications device message comprises one of:
a Small Messaging System (‘SMS’) message; or a Multimedia Messaging System (‘MMS’) message.

11. The apparatus of claim 9 wherein identifying environmental characteristics further comprises any of:
identifying presence of other individuals within the automobile at the time the message was received;
identifying weather conditions near the geographical location of the automobile at the time the message was received;
identifying a location of the automobile at the time the message was received; and
identifying a time of day that the message was received.

12. The apparatus of claim 11 wherein identifying presence of other individuals within the automobile at the time the message was received further comprises discovering within the automobile one or more additional mobile communications devices, each additional mobile communications device indicating presence of an additional other individual within the automobile.

13. The apparatus of claim 9 wherein the message characteristics of the message further comprise any of:
a source identifier;
a time the message was sent;
a geographic location from which the message was sent;
a device identifier from which the message was sent; and
content of the message.

14. The apparatus of claim 9 wherein administering presentation of content of the message on the automobile's display further comprises one of:
presenting the entire content of the message;
presenting a subset of the content of the message;
presenting no portion of the content of the message; and
presenting the content of the message with at least a portion of the content being modified.

15. A computer program product for filtering mobile communications device messages for presentation within an automobile, the automobile coupled for data communications to a user's mobile communications device, the computer program product disposed upon a computer readable storage medium, wherein the computer readable storage medium is not a signal, the computer program product comprising computer program instructions capable, when executed, of causing a computer to carry out the steps of:
responsive to the user's mobile communications device receiving a message, identifying, by a message display filter, message characteristics of the message;
identifying, by the message display filter, environmental characteristics of an operating environment that is external to the user's mobile communications device; and
administering, by the message display filter, presentation of content of the message within the automobile in dependence upon the message characteristics, the environmental characteristics, and a predefined message filtering ruleset.

16. The computer program product of claim 15 wherein the mobile communications device message comprises one of:
a Small Messaging System (‘SMS’) message; or
a Multimedia Messaging System (‘MMS’) message.

17. The computer program product of claim 15 wherein identifying environmental characteristics further comprises any of:
identifying presence of other individuals within the automobile at the time the message was received;
identifying weather conditions near the geographical location of the automobile at the time the message was received;
identifying a location of the automobile at the time the message was received; and
identifying a time of day that the message was received.

18. The computer program product of claim 17wherein identifying presence of other individuals within the automobile at the time the message was received further comprises discovering within the automobile one or more additional mobile communications devices, each additional mobile communications device indicating presence of an additional other individual within the automobile.

19. The computer program product of claim 15 wherein the message characteristics of the message further comprise any of:
a source identifier;
a time the message was sent;
a geographic location from which the message was sent;
a device identifier from which the message was sent; and
content of the message.

20. The computer program product of claim 15 wherein administering presentation of content of the message on the automobile's display further comprises one of:
presenting the entire content of the message;
presenting a subset of the content of the message;
presenting no portion of the content of the message; and
presenting the content of the message with at least a portion of the content being modified.
